(19) United States
(12) Patent Application Publication
(10) Pub. No.: US 2006/0028616 A1
(43) Pub. Date: Feb. 9, 2006

(54) Reading lens

(75) Inventor: Yin Sang Lam, Kowloon (HK)

Correspondence Address: FAEGRE & BENSON LLP;PATENT DOCKETING, 2200 WELLS FARGO CENTER, MINNEAPOLIS, MN, 55402, US

(73) Assignee: Okia Optical Co., Ltd., Kowloon (HK)

(21) Appl. No.: 10/910,189

(22) Filed: Aug. 3, 2004

(51) Int. Cl. G02C 7/06

(52) U.S. Cl. 351/168

(57) ABSTRACT

A lens includes a viewing area having a first optical power and a blended area located between the viewing area and an edge of the lens. The blended area includes a plurality of at least partially annular regions. Each of the regions has a different optical power lower than the first optical power of the viewing area. The innermost region includes a highest optical power among the regions, and each subsequent outer region has a gradually lower optical power.

### FIELD OF INVENTION

The present invention relates to a lens. In particular, the present invention relates to an improved thin reading lens.

### BACKGROUND OF INVENTION

Reading spectacles are essential for those with presbyopia. Prior art FIG. 1A shows a conventional positive optical power reading lens 46 having a top edge 50a, a bottom edge 50b, a left side edge 50c, and a right side edge 50d. The lens 46 has a single viewing area 52 with a positive optical power for presbyopia. This type of conventional lens is usually thick in nature and aesthetically unappealing, as illustrated in the cross sectional views in prior art FIGS. 1B and 1C taken along lines X-X and Y-Y of FIG. 1A respectively.

### SUMMARY OF INVENTION

According to one aspect of the present invention, there is provided a lens including a viewing area having a first optical power. The lens further includes a blended area located between the viewing area and the edge of the lens. The blended area includes a plurality of at least partially annular regions. Each of the regions has a different optical power lower than the first optical power of the viewing area. The innermost region includes a highest optical power among the regions, and each subsequent outer region has a gradually lower optical power.

In an embodiment of the present invention, the viewing area has a single focal point and is located at a central region of the lens. The plurality of at least partially annular regions are substantially concentric.

In another embodiment of the present invention, the blended area includes a peripheral region located along at least a portion of the edge of the lens. The peripheral region has an optical power close or equal to zero.

In yet another embodiment of the present invention, the viewing area is located generally at a central region of the lens.

In a further embodiment of the present invention, the blended area includes a plurality of annular regions.

According to another aspect of the present invention, there is provided a lens including a viewing area having a first optical power. The lens further includes a first at least partially annular region and a second at least partially annular region. The first at least partially annular region directly circumscribes the viewing area and has a second optical power lower than the first optical power. The second at least partially annular region directly circumscribes the first at least partially annular region and has a third optical power lower than the second optical power.

According to a further aspect of the present invention, there is provided a lens including a viewing area having a first optical power. The lens further includes a blended area at least partially circumscribing the viewing area. The blended area includes a plurality of at least partially annular regions. The at least partially annular regions have progressive optical powers lower than the first optical power of the viewing area and gradually decreasing in a radial outward direction.

As will be disclosed below, the present invention is a convenient and useful single vision thin reading lens. Other novel features and advantages will become apparent from the following detailed description of the invention when considered in conjunction with the accompanying drawings.

### BRIEF DESCRIPTION OF THE DRAWINGS

FIG. 1A is a front view of a conventional reading lens.

FIGS. 1B and 1C are cross-sectional views of the conventional reading lens of FIG. 1A taken along lines X-X and Y-Y respectively.

FIG. 2A is a front view of a thin reading lens in accordance with an embodiment of the present invention.

FIG. 2B is a cross-sectional view of the thin reading lens of FIG. 2A taken along line L-L. FIG. 2C is a magnified cross-sectional view of the thin reading lens of FIG. 2A taken along line M-M respectively.

FIG. 3 is a front view of a thin reading lens in accordance with a first specific embodiment of the present invention.

FIG. 4 is a front view of a thin reading lens in accordance with a second specific embodiment of the present invention.

FIG. 5 is a pair of spectacles with the thin reading lens of FIG. 2A according to an implementation of the present invention.

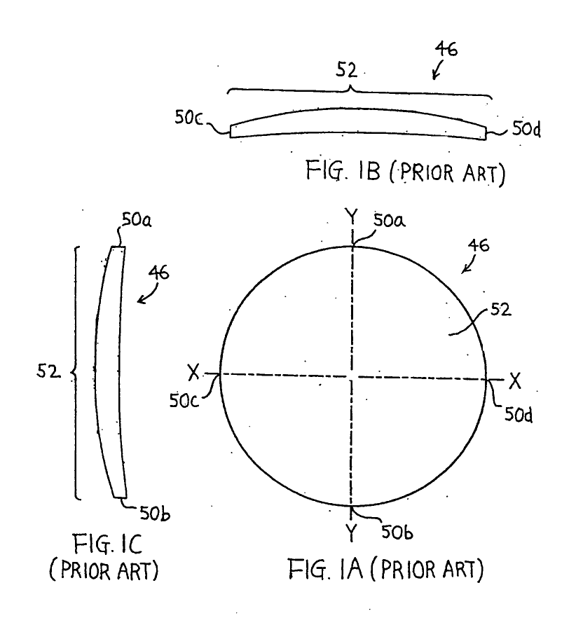

### DETAILED DESCRIPTION OF THE PREFERRED EMBODIMENT

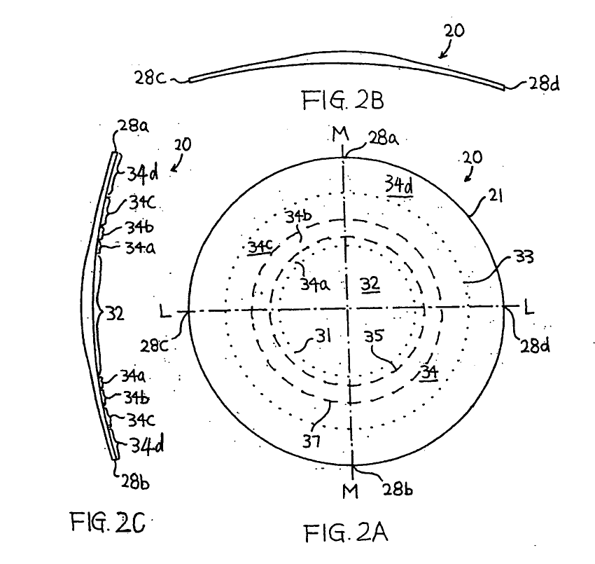

Certain terminology is used in the following description for convenience only and is not intended to be limiting. Particularly, the terms “top,” “bottom,” “left,” and “right” designate directions in the drawings to which reference is being made. Further, when referring to “optical power” what is meant is the measurement of how strongly a lens bends incoming rays. Referring now to the drawings, in which like reference numerals represent like parts throughout the drawings, FIGS. 2A-C illustrate a thin reading lens, generally represented by reference numeral 20, in accordance with an embodiment of the present invention. The thin reading lens 20 can be mounted on a frame of a pair of spectacles or eyeglasses. The lens 20 has an edge 21 which includes a top edge 28a, a bottom edge 28b, a left side edge 28c, and a right side edge 28d. According to an embodiment of the present invention, the lens 20 contains a viewing area 32 and a blended area 34 between the viewing area 32 and the edge 21 of the lens 20. The optical lens includes a concave side (spherical part) and a convex side (aspherical part). The optical power is based on the curvature of the aspherical lens profile (the convex side of the lens). In other words, the optical power varies with the radius of the aspherical lens profile, while the spherical part (the concave side of the lens) keeps a constant single radius. The greater the radius of the curvature of the aspherical lens profile is, the lower the optical power will be. The thicknesses of the annular regions are the outcomes of the various radii.

The viewing area 32, generally located inside a first boundary 31, has a positive optical power and a single focal point. The viewing area 32 is generally located at or adjacent to a central region of the lens 20.

The blended area 34 is generally located between the first boundary 31 and edge 21. In the illustrated embodiment, the blended area 34 may contain four substantially concentric regions with different optical powers.

Referring particularly to FIGS. 2A and 2C, the first substantially concentric region 34a is positioned between the first boundary 31 and a second boundary 35. The second substantially concentric region 34b is positioned between the second boundary 35 and a third boundary 37. The third substantially concentric region 34c is positioned between the third boundary 37 and the fourth boundary 33. The fourth substantially concentric region 34d is generally located between the edge 21 of the lens 20 and the fourth boundary 33.

In the illustrated embodiment, the first substantially concentric region 34a directly circumscribes the viewing area 32. The second substantially concentric region 34b directly circumscribes the first substantially concentric region 34a. The third substantially concentric region 34c directly circumscribes the second substantially concentric region 34b. The fourth substantially concentric region 34d directly circumscribes the third substantially concentric region 34c.

Each of the substantially concentric regions 34a, 34b, 34c, 34d is prescribed with a different optical power. All of the regions 34a, 34b, 34c, 34d however, have lower optical powers than that of the viewing area 32. The optical powers are reduced gradually from the innermost concentric region 34a to the outermost region 34d. The innermost concentric region 34a contains the highest optical power among the four regions 34a, 34b, 34c, 34d, while the outermost region 34d contains the lowest optical power among the four regions 34a, 34b, 34c, 34d. The fourth substantially concentric region 34d may have an optical power close or equal to zero.

In the illustrated embodiment, the substantially concentric regions 34a, 34b, 34c, 34d are all substantially annular in shape. However, it is appreciated that one or more of these substantially concentric regions 34a, 34b, 34c, 34d can have a partially annular configuration. In the illustrated embodiment, four substantially concentric regions 34a, 34b, 34c, 34d are included in the blended area 34 for illustration purpose. It is to be understood that the blended area 34 may contain only two or three substantially concentric regions or more than four substantially concentric regions. Further, although it has been shown and described that the blended area 34 contains substantially concentric regions, it is appreciated that the blended area 34 may contain regions that are not concentric.

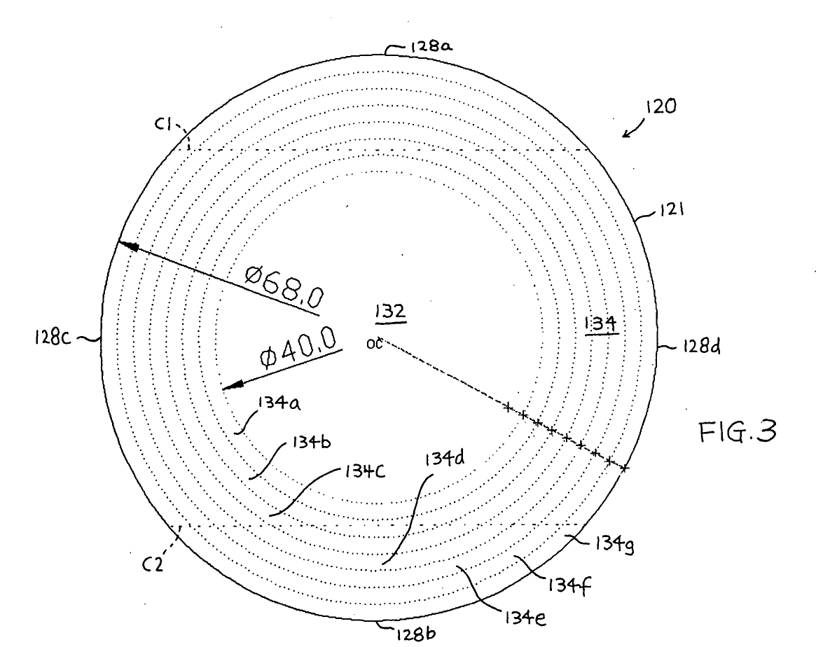

FIG. 3 is a front view of a thin reading lens in accordance with a first specific embodiment of the present invention. The thin reading lens, designated generally by reference numeral 120, is generally circular in shape and has a viewing area 132 and a blended area 134.

The viewing area 132 has an optical power and a single focal point. The viewing area 132 is located at a central region of the lens 120 with the blended area 134 circumscribing the viewing area 132. The blended area 134 is located between the viewing area 132 and an edge 121 of the lens 120. The edge 121 includes a top edge 128a, a bottom edge 128b, a left side edge 128c, and a right side edge 128d.

According to the present embodiment, the blended area 132 may include seven annular regions 134a, 134b, 134c, 134d, 134e, 134f, 134g circumscribing the viewing area 132. The annular regions 134a, 134b, 134c, 134d, 134e, 134f, 134g are in concentric relationship.

Each of the annular regions 134a, 134b, 134c, 134d, 134e, 134f, 134g has a different optical power lower than the optical power of the viewing area 132, with an innermost region 134a including a highest optical power among the annular regions 134a, 134b, 134c, 134d, 134e, 134f, 134g, and the subsequent outer regions 134b, 134c, 134d, 134e, 134f, 134g each having a gradually lower optical power.

Particularly, the first and innermost region 134a, generally annular in shape, directly circumscribes the viewing area 132 and has an optical power lower than the optical power of the viewing area 132. The second region 134b, generally annular in shape, directly circumscribes the first annular region 134a and has an optical power lower than the optical power of the first annular region 134a. The third region 134c, generally annular in shape, directly circumscribes the second annular region 134b and has an optical power lower than the optical power of the second annular region 134b. The fourth region 134d, generally annular in shape, directly circumscribes the third annular region 134c and has an optical power lower than the optical power of the third annular region 134c. The fifth region 134e, generally annular in shape, directly circumscribes the fourth annular region 134d and has an optical power lower than the optical power of the fourth annular region 134d. The sixth region 134f, generally annular in shape, directly circumscribes the fifth annular region 134e and has an optical power lower than the optical power of the fifth annular region 134e. The seventh and outermost region 234g, generally annular in shape, directly circumscribes the sixth annular region 134f and has an optical power lower than the optical power of the sixth annular region 134f.

In this embodiment, the viewing area 132 has an optical power of +2.00 D, the first and innermost annular region 134a has an optical power of +1.75 D; the second annular region 134b has an optical power of +1.50 D; the third annular region 134c has an optical power of +1.25 D; the fourth annular region 134d has an optical power of +1.00 D; the fifth annular region 134e has an optical power of +0.75 D; the sixth annular region 134f has an optical power of +0.50 D; and the seventh and outermost annular region 134g has an optical power of +0.25 D or less.

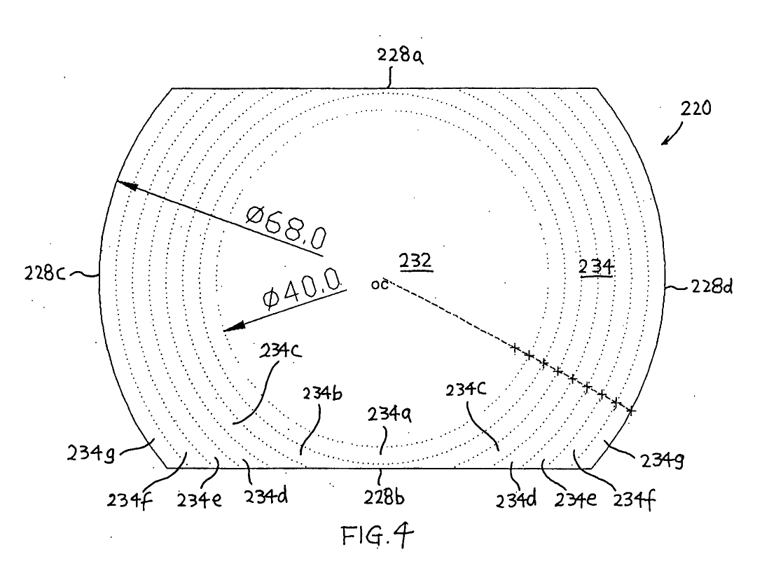

FIG. 4 is a front view of a thin reading lens in accordance with a second specific embodiment of the present invention. The thin reading lens, designated generally by reference numeral 220, is initially the same as the lens 120 of FIG. 3 but is cut along the two dotted lines C1, C2 shown in FIG. 3 forming the lens 220. The lens 220 shown in FIG. 4 has a generally linear top edge 228a, a generally linear bottom edge 228b, a curved left side edge 228c, and a curved right side edge 228d. The lens 220 has a viewing area 232 and a blended area 234.

The viewing area 232 has an optical power and a single focal point. The viewing area 232 is located at a central region of the lens 220 with the blended area 234 circumscribing the viewing area 232. The blended area 234 is located between the viewing area 232 and the edges 228a, 228b, 228c, 228d of the lens 220.

The blended area 234 includes annular and partially annular regions 234a, 234b, 234c, 234d, 234e, 234f, 234g. Each of the annular and partially annular regions 234a, 234b, 234c, 234d, 234e, 234f, 234g has a different optical power lower than the optical power of the viewing area 232, with an innermost region 234a including a highest optical power among the annular or partially annular regions 234a, 234b, 234c, 234d, 234e, 234f, 234g and the subsequent outer regions 234b, 234c, 234d, 234e, 234f, 234g each having a gradually lower optical power.

Particularly, the first and innermost region 234a, generally annular in shape, directly circumscribes the viewing area 232 and has an optical power lower than the optical power of the viewing area 232. The second region 234b, generally annular in shape, directly circumscribes the first annular region 234a and has an optical power lower than the optical power of the first annular region 234a. The third region 234c, partially annular in shape, directly circumscribes the second annular region 234b and has an optical power lower than the optical power of the second annular region 234b. The fourth region 234d, partially annular in shape, directly circumscribes the third annular region 234c and has an optical power lower than the optical power of the third annular region 234c. The fifth region 234e, partially annular in shape, directly circumscribes the fourth annular region 234d and has an optical power lower than the optical power of the fourth annular region 234d. The sixth region 234f, partially annular in shape, directly circumscribes the fifth annular region 234e and has an optical power lower than the optical power of the fifth annular region 234e. The seventh and outermost region 234g, partially annular in shape, directly circumscribes the sixth annular region 234f and has an optical power lower than the optical power of the sixth annular region 234f.

In this embodiment, the viewing area 232 has an optical power of +2.00 D, the first and innermost annular region 234a has an optical power of +1.75 D; the second annular region 234b has an optical power of +1.50 D; the third annular region 234c has an optical power of +1.25 D; the fourth annular region 234d has an optical power of +1.00 D; the fifth annular region 234e has an optical power of +0.75 D; the sixth annular region 234f has an optical power of +0.50 D; and the seventh and outermost annular region 234g has an optical power of +0.25 D or less.

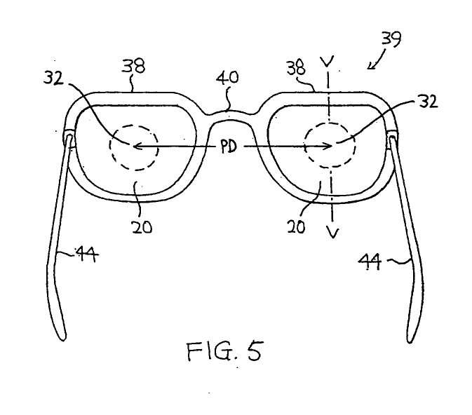

FIG. 5 illustrates an implementation of the present invention showing a pair of spectacles of eyeglasses 39 with the thin reading lens 20 described above. The eyeglasses 39 may include a pair of temples 44 and a pair of lens frames 38 for mounting a pair of the thin reading lens 20. The lens frames 38 are connected together by a bridge 40. The position of a wearer's pupil generally coincides with the viewing area 32 of the reading lens 20. In other words, the wearer's eyes can be in the same level as the center of the viewing area. In a typical implementation according to the present invention, the viewing area 32 is preferably positioned at the center of the lens frame 38 relative to a generally vertical axis V-V thereof. Preferably, the pupilary distance PD between the optical centers in the two viewing areas 32 of the two lenses 20 is about 62 mm to about 64 mm apart.

The thin reading lens of the present invention can be manufactured by injection molding. The mold may contain a plurality of cavities for mold inserts.

As described above, the viewing area 32 of the thin reading lens 20 is generally located at or adjacent to the central region of the lens 20. Preferably, the blended area 34 is precisely calculated to prevent appearance of any boundary line between the viewing area 32 and the blended area 34. Therefore an ultra-precision turning machine is necessary to make the mold inserts. The accuracy of this machine is preferably in a nanometer range to ensure that the thin reading lens of the present invention has the best surface characteristics.

The ultra-precision turning machine is computer controlled. Specially calculated curve equations are inputted into a console of the machine. As the reading lens has more than one curvature, the curve equations include equations for the viewing and blended areas.

While the present invention has been described using the aforementioned figures and the specific examples of the lenses, it is understood that these are examples only and should not be taken as limitation to the present invention. It should also be understood that the reading lens mentioned above represents one embodiment of the present invention and the same principle of the present invention can also apply to other configurations or designs.

I claim:

1. A lens having an edge, the lens comprising:
a viewing area including a first optical power; and
a blended area located between the viewing area and the edge, the blended area including a plurality of at least partially annular regions, each of the regions including a different optical power lower than the first optical power of the viewing area, with an innermost region including a highest optical power among the regions, and each subsequent outer regions including a gradually lower optical power.

2. The lens of claim 1 wherein the viewing area includes a single focal point.

3. The lens of claim 1 wherein the plurality of at least partially annular regions are substantially concentric.

4. The lens of claim 1 wherein the blended area includes a peripheral region located along at least a portion of the edge of the lens, and wherein the peripheral region includes an optical power close or equal to zero.

5. The lens of claim 1 wherein the viewing area is located generally at a central region of the lens.

6. The lens of claim 1 wherein the blended area includes a plurality of substantially annular regions.

7. A lens comprising:
a viewing area including a first optical power;
a first at least partially annular region directly circumscribing the viewing area and having a second optical power lower than the first optical power; and
a second at least partially annular region directly circumscribing the first at least partially annular region and having a third optical power lower than the second optical power.

8. The lens of claim 7 wherein the viewing area includes a single focal point.

9. The lens of claim 7 wherein the first and second at least partially annular regions are substantially concentric.

10. The lens of claim 7 further comprising a peripheral region located along at least a portion of the edge of the lens, the peripheral region including an optical power close or equal to zero.

11. The lens of claim 7 wherein the viewing area is located generally at a central region of the lens.

12. The lens of claim 7 wherein the first and second at least partially annular regions are substantially annular in shape.

13. A lens comprising:
a viewing area including a first optical power; and
a blended area at least partially circumscribing the viewing area, the blended area including a plurality of at least partially annular regions including progressive optical powers lower than the first optical power of the viewing area and gradually decreasing in a radial outward direction.

14. The lens of claim 13 wherein the viewing area includes a single focal point.

15. The lens of claim 13 wherein the plurality of at least partially annular regions are substantially concentric.

16. The lens of claim 13 wherein the blended area includes a peripheral region located along at least a portion of the edge of the lens, and wherein the peripheral region includes an optical power close or equal to zero.

17. The lens of claim 13 wherein the viewing area is located generally at a central region of the lens.

18. The lens of claim 13 wherein the blended area includes a plurality of substantially annular regions.

19. The lens of claim 13 wherein the blended area circumscribes the viewing area.
